(19) United States
(12) Patent Application Publication
(10) Pub. No.: US 2024/0092706 A1
(43) Pub. Date: Mar. 21, 2024

(54) DRUM COMPOSTER, COMPOSTING DRUM USED IN THIS AND COMPOSTING METHOD

(71) Applicant: PROFIKOMP KÖRNYEZETTECHNIKA ZRT., Godollo (HU)

(72) Inventor: László ALEKSZA, Godollo (HU)

(73) Assignee: PROFIKOMP KÖRNYEZETTECHNIKA ZRT., Godollo (HU)

(21) Appl. No.: 17/766,766

(22) PCT Filed: Oct. 14, 2020
(86) PCT No.: PCT/HU2020/050048

§ 371 Date: Apr. 6, 2022

(30) Foreign Application Priority Data
Dec. 3, 2019 (HU) P1900409

(51) Int. Cl. C05F 17/929

(52) U.S. Cl. CPC C05F 17/929

(57) ABSTRACT

The object of the invention relates to a composting drum (1) used with drum composters, a shell (3) of which composting drum (1) has perforations (4), the composting drum (1) has an opening (7) suitable for inserting material to be composted, where the shell (3) of the composting drum (1) is provided with perforations (4) suitable for the removal of the compost particles and the perforated shell (3) of the composting drum (1) is covered in a removable way with a semipermeable membrane (6) at least over the part with perforations (4). The object of the invention also relates to drum composters containing such a composting drum (1), to a composting method performed with such a composting drum (1), and to a semipermeable membrane (6) for use with such a composting drum (1).

### THE SCOPE OF THE INVENTION

The object of the invention relates to a drum composter suitable for composting biodegradable waste. The object of the invention also relates to a composting drum used in drum composters, and to a composting method too.

### THE BACKGROUND OF THE INVENTION

Composting is a waste treatment method for utilising biodegradable waste, during which the biodegradable waste is transformed into compost, fertilising and soil-improving material, primarily used in horticulture.

Degrading microorganisms have an active role in composting. Composting is an aerobic process, i.e. it needs the presence or the provision of atmospheric oxygen.

Important parameters during the composting process are temperature and moisture content, which need to be taken into consideration with respect to the optimal operation of the composting microorganisms and other chemical processes accompanying the composting process. Temperature and the moisture content change constantly as a consequence of the chemical and biological processes taking place.

An important effect of composting is the emission of smells, which must be taken into special account both at industrial composting plants and in the environment around the house with a view to their unpleasant nature.

During the composting method, the material being composted must be moved or mixed at appropriate intervals in the interest of the oxygen demand of the process being fulfilled everywhere and so that anaerobic processes can be avoided. This movement may even be continuous.

The time spent in the composting apparatus influences the efficiency of the method used for composting the material to be composted, as the faster the process proceeds, the more frequently it may be refilled, and so the utilisation of the composting apparatus becomes better.

The composting methods used in industrial and domestic settings and the apparatus used to implement such methods differ in many respects. While the industrial methods and apparatuses are optimised for the type of biodegradable waste to be composted, those used around the house are designed to process the many types of biodegradable waste that may be found in an average household or garden. Industrial apparatuses are usually operated continuously, while those used at home are usually intermittent. Mechanical differences also arise between them as a result of the differing scale (e.g. rotating, aeration, etc.). Nevertheless, there is compatibility between the two areas of use, with no sharp dividing line between industrial and domestic composting existing, as it is essentially the same microbiological and chemical processes that take place in both cases.

With consideration to the abovementioned factors numerous composting apparatuses are known of.

Drum composters are composting apparatuses that contain one or more rotating composting drums. The composting process takes place inside the composting drum. The composting drum may be rotated manually or mechanically.

The composting drum of drum composters may be cylindrical or polygonal in cross-section. In the case of cylindrical composting drums it may occur that the material to be composted slides on the internal surface of the composting drum, thereby reducing the efficiency of mixing. A solution to this problem is the use of a polygonal composting drum (see U.S. Pat. No. 3,837,810, for example). Furthermore mixing elements used inside the composting drum may act as a solution to the mixing problem resulting from sliding.

The composting drum of drum composters is frequently perforated, which, on the one part, facilitates aeration, and, on the other part, makes it possible to obtain finished (mature) compost of the appropriate grain size and allows the drainage of leachate from the drum. The US-based U.S. Pat. No. 4,946,108, for example, discloses a drum composter that has at least partially perforated sides. Here the perforations are dimensioned so that the fine compost particles are able to leave the drum. Canadian patent application number CA2026984A discloses a drum composter made from used vehicle tyres, where, optionally, the tyres are perforated. A drum composter is also known of which has a composting drum with a polygonal cross-section, with one of its sides being formed as a sieve in order to ensure that finished (mature) composted can fall out (German utility model number DE29823058U1).

The necessary aeration in drum composters may also be implemented by a perforated aeration tube running inside the composting drum, such as in the case of the solution disclosed in US patent application publication number US 2013/0052726 A1, for example, where the perforated pipe used for aeration is the axle of the drum composter. U.S. Pat. No. 5,776,768 discloses a multi-section rotating composter the first section of which is used for inserting the material to be composted, and the last section of which is used for removing the compost, while the composting takes place in the intermediate sections. Air is made to flow through the sections, which air, in the case of low ambient air temperatures, is heated. The flow direction of the air is opposite to the direction of flow of the material to be composted, and the composting drum is insulated so that the air introduced flows though the material to be composted.

According to Canadian patent application number CA2287672A1 a general problem with small sized composters is, on the one part, the efficiency of mixing, and, on the other part, fast loss of heat due to the small size, an additional problem is regulating the liquid. An important element of the solution disclosed here is that the composting drum is surrounded by insulation. Additionally, US patent application publication number US 2002/0090718 A1 discloses a drum composter containing a multilayer, heat-insulated drum wall.

US patent application publication number US 2004/0142461 A1 offers a solution to the problem of insulation and suitable simultaneous aeration, which discloses a polygonal cross-sectioned drum composter where aeration takes place by there being a perforated panel along one of the closed walls, and then air is blown in between the wall and the panel.

US patent application publication number US 2004/0009587 A1 discloses a garden drum composter with a rectangular cross-section, two sides of which consist of netting and a black panel may be secured over the netting in such a way that it may be removed. When these black panels are in position, the flow of air is reduced, which results in a higher internal temperature. When the composting is at least partially completed, the black panels are removed and then the composter is rotated so that the finished (mature) compost may leave through the netting revealed by the removal of the panels.

German utility model number DE9208572U1 relates to a rotatable, perforated drum composter for use around the house. In the case of the solution disclosed here, the rotatable composting drum is surrounded by an upright housing that may be opened. The housing that may be opened has air inlet and outlet openings and the flow of air gets to the material to be composted inside the composting drum through holes in the composting drum and leaves through the holes in the composting drum. The shaft of this drum composter is necessarily inclined. The formed small compost particles continuously leave the composting drum along with the leachate into a collection vessel.

The essence of the garden composter according to German utility model number DE8013598U1 is that the composting drum consists of an external shell and an internal shell at a distance of 2 to 5 cm from it. The external shell is made from a smooth material, while the internal shell is a wire mesh. The external shell may be, for example, steel or plastic and is only perforated for the securing elements. The external shell is dark so it may absorb solar energy.

European patent application number EP0847971A2 discloses a cylindrically shaped drum composter for domestic use. The purpose of this, in addition to ensuring the appropriate temperature and mixing, is also to ensure the aerobic conditions. The composting drum is multi-layered, and contains an air-permeable layer, an external protective layer, and, optionally, a layer of insulation. The composting drum contains an opening for inserting the material to be composted and for removing the finished (mature) compost.

The disadvantage of the drum composter solutions according to the state of the art is that the tasks of aeration and insulation are performed by different devices, thereby making the structure of the apparatus complex, costly, and they involve numerous fault possibilities. A further disadvantage of the known household drum composters is that they are emptied either through an aperture formed for this purpose or through the perforations in the composting drum surface. However, in the latter case the insulation is only possible with a surface located at a distance from the composting drum. In this respect insulation is understood to mean insulation against moisture.

The objective of the present invention is to provide a drum composter that is free of the disadvantages of the solutions according to the state of the art.

It was recognised that if a drum composter is used that has a composting drum having perforations suitable for removing the finished (mature) compost, and the composting drum is covered from the outside with a semipermeable membrane in such a way that it may be removed, then this drum composter is free of the disadvantages of the drum composters according to the state of the art.

The reason for this is that the semipermeable membrane, on the one part, permits aeration of the composting drum, thereby ensuring the aerobic conditions required for composting, and, on the other part, is not permeable to moisture, in this way the appropriate moisture conditions are maintained in the composting drum during the composting process. When the composting process is partially or entirely completed, by removing the semipermeable membrane the perforations in the composting drum become revealed, and so the particles of finished (mature) compost may leave the composting drum through these perforations over the course of a number of rotations. Following this, by replacing the semipermeable membrane the composting process may be continued, optionally new material to be composted may be placed into the composting drum through an opening formed for this purpose.

A significant advantage of the solution according to the present invention is that smaller, but still not composted particles do not leave the composting drum too early. Because, in the case of drum composters using only a perforated sheet or wire mesh as the wall of the composting drum, the smaller particles (e.g. coffee grounds) leave the composting drum almost immediately, meaning that these do not get composted. In the case of the solution according to the present invention, however, the semipermeable membrane shuts off the perforations of the composting drum and these only become permeable if the user, after a suitable composting time has passed, temporarily removes the semipermeable membrane from the composting drum.

In addition, the semipermeable membrane significantly reduces the smell emissions originating from inside the composting drum.

### A BRIEF DESCRIPTION OF THE FIGURES

FIG. 1 shows a perspective view of a composting drum according to the present invention, which may be rotated around a shaft, and the shell of which has perforations formed in the middle region as a mesh and these are partially covered by a semipermeable membrane.

FIG. 2 shows a perspective view of a composting drum according to the present invention, which may be rotated around a shaft, and the shell of which has mesh-formed perforations over its entire extent and this is partially covered by a semipermeable membrane.

FIG. 3 show a perspective view of a drum composter that may be rotated with external wheels, the drum of which is entirely covered with a semipermeable membrane (FIG. 3a), or the drum of which has no semipermeable membrane (FIG. 3b).

FIG. 4 show an enlarged detail of the shell of the composting drum according to the present invention, where in FIG. 4a the perforation is in the form of a mesh, and in FIG. 4b the perforations are formed by a multitude of holes.

### A BRIEF DESCRIPTION OF THE INVENTION

The object of the present invention relates to a composting drum used with drum composters, which composting drum has an opening adapted for inserting the material to be composted, and it is characteristic of which composting drum that its shell is provided with perforations for removing the compost particles and the perforated shell of the composting drum is covered with a removable semipermeable membrane at least on the surface part above the perforations.

According to a preferred embodiment the semipermeable membrane of the composting drum is secured with a hook-and-loop fastener.

According to another preferred embodiment the shell of the composting drum is cylindrical.

According to yet another preferred embodiment the holes forming the perforations are distributed approximately evenly over the entire surface of the shell.

According to a further preferred embodiment the average diameter of the holes forming the perforations is in the range of 10 to 20 mm.

According to another preferred embodiment the semipermeable membrane contains a protective layer and a functional layer.

According to a further preferred embodiment the average pore size of the semipermeable membrane is a maximum of 0.5 micrometres, preferably a maximum of 0.3 micrometres.

The object of the present invention also relates to a drum composter, which has a composting drum with a perforated shell, a device adapted for rotating the composting drum, an opening in the composting drum for inserting the material to be composted, and, optionally, a frame for supporting the composting drum, and it is characteristic of the drum composter that the perforated shell of the composting drum is provided with perforations for removing the particles of compost and the perforated shell of the composting drum is covered with a removable semipermeable membrane at least over the surface part above the perforations.

The object of the present invention also relates to the use of a semipermeable membrane for composting performed with a drum composter, where the composting drum of the drum composter, i.e. essentially its shell, is provided with perforations for removing the particles of compost and the semipermeable membrane covers the perforated shell of the composting drum in a removable way at least above the surface part provided with perforations.

Furthermore, the object of the present invention also relates to a method for composting biodegradable waste, which method contains the following steps:
a) inserting material to be composted into a composting drum according to the above of a drum composter, i.e. essentially into a composting drum which has a shell provided with perforations for removing the particles of compost, where the perforated shell of the composting drum is covered with a semipermeable membrane at least on the surface part above the perforations;
b) rotating the drum composter at given intervals or continuously for as much time so that the composting process is at least partially completed;
c) removing the semipermeable membrane from the perforated shell of the composting drum;
d) rotating the drum composter in the interest of at least a part of the finished (mature) compost leaving through the perforations of the composting drum.

### DETAILED DESCRIPTION OF THE INVENTION

In the scope of the present invention biodegradable waste is understood to mean all biologically degradable waste. In other words, biodegradable waste is all waste containing organic material that biologically degrades or breaks down in an aerobic or anaerobic way. A subset of biodegradable waste includes the kitchen and garden waste listed in the category of communal solid waste, which, in short, is called biowaste. Apart from biowastes, biodegradable wastes also includes, for example, sewage sludge, foodstuff industry waste, biopolymers, etc. The object of the present invention relates to the composting of biodegradable wastes.

The object of the present invention relates to a composting method during which it is essentially aerobic processes that take place, and to an apparatus in which aerobic composting may be performed.

In the scope of the present invention finished (mature) compost is viewed as being biologically stable, soil-like material that has a high humus content.

In other words the object of the present invention relates to a solution, where, on the one part, the composting drum of the drum composter is perforated, which perforations, on the one part, ensure aeration, and, on the other part, their hole size is selected so that the finished (mature) compost is able to leave easily. On the other part, a removable semipermeable membrane is secured to the composting drum, which covers the perforations in the shell of the composting drum, thereby preventing smaller sized particles from falling out and liquid from leaving before the composting process has come to an end, but also ensuring aeration. By removing the semipermeable membrane the perforations in the composting drum become free and in this way the small sized particles of finished (mature) compost are able to easily leave the composting drum. Following this the semipermeable membrane may be replaced onto the composting drum and composting may be continued, even with the addition of new material to be composted.

The solution according to the present invention may be used for both industrial and household drum composters.

The shape of the composting drum of the drum composters according to the present invention may be selected from composting drums with a polygonal cross-section or that are cylindrical, in other words the shape of the composting drum may be block-shaped or cylindrical. However, with respect to that it is preferable that the semipermeable membrane fits onto the surface of the composting drum as precisely as possible in order to effectively cover the perforations, therefore, according to a preferred embodiment, the composting drum is cylindrical in shape, i.e. the composting drum is in the shape of a straight elliptical or straight circular-based cylinder, most preferably in the shape of a straight circular-based cylinder.

Drum composters containing a perforated composting drum are known of according to the state of the art. Unless something else is expressly mentioned, perforated composting drum in the scope of the present specification is understood to mean that the perforations may be found in the shell of the composting drum. Perforations essentially mean a multitude of holes in the shell of the drum. The holes forming the perforations are distributed approximately evenly over the entire surface of the shell, or they may be located on just one part of the shell. In the interest of efficient operation the holes forming the perforations are preferably approximately evenly distributed on the entire surface of the shell. Perforations suitable for enabling the compost particles to leave are understood to mean that the size of the holes forming the perforations is selected so that the finished (mature) compost particles are able to leave through them. Here it must be taken into consideration that one of the tasks of the perforation is to provide aeration under the circumstance that the perforations are covered by a semipermeable membrane. It is obvious for a person skilled in the art that the minimal aeration surface provided by the perforations as compared to the entire surface of the shell of the composting drum is an important parameter, while the maximum proportion of the surface determined by the perforations is essentially not limited. In this way, according to the meaning of the present invention the perforated shell of the composting drum may even be created in the form of a mesh. The holes forming the perforations may be circular or elliptical in shape, or even be in the form of a longitudinal slit, and a combination of all these is also conceivable. Nevertheless, it is important for the size of the holes forming the perforations to correspond to the average particle size of the finished (mature) compost.

The base of the block or cylinder forming the composting drum does not contain the perforations according to the present invention. Nevertheless, holes serving simple aeration may be optionally formed in these surfaces. Furthermore, these surfaces preferably contain the one or more openings for inserting the biodegradable waste to be composted, and the shaft for rotating the composting drum may be connected to these surfaces.

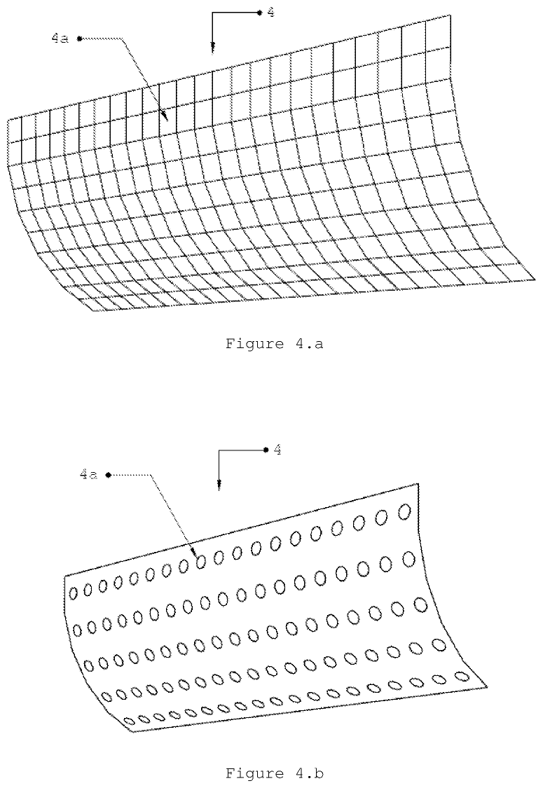

According to the present invention the average size of the holes forming the perforations in the composting drum is selected to correspond with the average particle size of the finished (mature) compost, i.e. so that the particles of the finished (mature) compost may easily leave the composting drum if the semipermeable membrane has been removed. It is obvious for a person skilled in the art that the optimal average hole size depends on several parameters, e.g. on the biodegradable waste to be composted, the expected quality of the finished (mature) compost, etc. According to the present invention the average hole diameter is preferably in the range of 10 to 20 mm. For example, composting performed with a composting drum with perforations formed by holes with average diameter of 10 mm results in less but better quality compost, while composting performed with a composting drum with perforations formed by holes with an average diameter of 20 mm results in a greater quantity of compost but at not such good quality. The diameter of the hole in the case of circular holes is understood to mean the diameter of the circle, and in the case of holes that are not circular, the diameter of the hole is understood to mean the smallest distance between two facing edges of the hole. The perforations in the composting drum may also be formed in such a way that holes are drilled or gaps cut at given distances from each other in the shell of the composting drum, or the perforations may even be formed with a mesh. In other words, according to the present invention perforations are understood to mean a multitude of holes (FIG. 4.b) or a mesh (4.a).

Holes that are of such a small size so that they do not permit the particles of compost to leave freely are not considered to be holes forming perforations. Therefore embodiments also belong to the scope of protection of the present invention in the case of which such small holes optionally created in the surface of the composting drum are possibly not covered by the semipermeable membrane.

The material of the composting drum is worthwhile selecting so that it withstands the effects usually created/existing during composting (e.g. temperature higher than the ambient temperature, corrosive environment, external physical effects, etc.). The choice of material may also affect the dimensioning. While the composting drums of smaller sized composters designed for household use may even be made from plastic, in the case of larger sized apparatus the selection of stainless steel or aluminium is preferred.

According to the present invention the shell of the perforated composting drum is covered with a semipermeable membrane for the duration of the composting process. The semipermeable membrane, on the one part, permits air to pass through it, which gets into the interior of the composting drum through the perforations in the shell of the composting drum, and releases the water vapour and other gases created in the interior of the composting drum. As the semipermeable membrane is permeable to water vapour, its use enables the moisture content to be kept in equilibrium. However, the semipermeable membrane does not permit liquid phase water to pass through it, therefore there is no great loss of liquid during the composting process. On the other part, the semipermeable membrane does not permit precipitation arriving from the outside to pass through it, in this way rain does not substantially affect the composting process either, in other words the composter according to the invention may also be used in the open air without problem. The problem of too high moisture content resulting from the accumulation of leachate does not occur either in the case of drum composters according to the present invention, the reason for this is that precipitation water does not get into the interior of the drum due to the covering of the semipermeable membrane, and, on the other part, the water formed in the course of biological degradation is released in the form of vapour. Consequentially leachate water does not have to be drained off and water does not have to be added to ensure suitable moisture content. According to the present invention the semipermeable membrane is a membrane that permits the components of air (this includes the air in the open and the air formed in the drum composter during composting) and water vapour to pass through it, but does not permit liquid or solid phase materials to pass through it.

According to the present invention the semipermeable membrane preferably contains a protective layer and a functional layer. The protective layer, on the one part, protects the functional layer from mechanical impacts, and, on the other part, it performs a carrier function. The protective layer may be made from polyester, for example. The functional layer performs the semipermeable tasks, i.e. the structure of this ensures that certain materials may pass through the membrane and other materials are retained. The functional layer may be made of expanded polytetrafluoroethylene (PTFE).

The functional layer determines the pore size of the semipermeable membrane. According to the present invention the average pore size of the semipermeable membrane is a maximum of 0.5 micrometres, preferably a maximum of 0.3 micrometres. In addition to this pore size ensuring the property of permitting gases to pass through it and not permitting liquid/solid materials to pass through it, this pore size is not permeable to most bacteria, including human pathogens. Therefore the drum composter according to the invention is substantially closed from a microbiological point of view during the composting process.

Therefore, a semipermeable membrane is secured on the shell of the composting drum of the drum composter according to the invention in the interest of covering the perforations and only permitting the exchange of gas between the interior of the composting drum and the environment. As a consequence of this the semipermeable membrane must be placed on the part of the shell of the composting drum where the composting drum is perforated, in other words at least on the surface part below the perforations. If the composting drum is only partially perforated, it is sufficient to secure the semipermeable membrane onto the composting drum to cover just this part. It is important for the semipermeable membrane to cover all of the holes forming the perforations on the shell of the composting drum in the interest of it being able to efficiently perform its function. This is not necessary the other way around, i.e. it is obviously not a problem if the semipermeable membrane covers parts where there are no perforations on the shell of the composting drum. Nevertheless, the simplest and therefore preferred embodiment is the case when the semipermeable membrane covers the entire shell of the composting drum.

In order to separate the finished (mature) compost the semipermeable membrane needs to be removed from the composting drum, then after the finished (mature) compost has been removed it must be secured to it again in order to continue the composting or start new composting. The semipermeable membrane may be secured to the shell of the composting drum in known ways. For example, hooks secured to the shell of the composting drum or to its edge may be used, which the semipermeable membrane may be hooked onto using holes formed in it for this purpose. The semipermeable membrane may also be wrapped around the shell of the composting drum and secured to its own material, using a hook-and-loop fastener according to a preferred embodiment.

The composting drum of the drum composter according to the present invention contains at least one opening through which the biodegradable waste to be composted may be added into the composting drum. Furthermore, this opening may used to access the interior of the composting drum, in the case of cleaning and maintenance, for example, and the larger parts that have not composted may be removed through this opening. These one or more openings may be formed in the bases of the block or cylinder forming the composting drum and/or in the shell of the composting drum.

Ensuring aerobic conditions may take place with passive aeration (essentially without forced aeration, through the perforations in the perforated composting drum and the semipermeable membrane), and/or may also take place with active aeration (with positive aeration in a pressure system, e.g. using a fan). Passive aeration is preferable in the case of smaller, household drum composters, while active aeration is preferable in the case of industrial drum composters.

The rotation of the composting drum of the drum composter according to the present invention may take place with the devices known of in the case of drum composters using manual or mechanical force, continuously or intermittently. In the case of an embodiment the rotation may take place through a shaft connected to the middle of the bases of the block or cylinder forming the composting drum. According to another embodiment the rotation may also take place with external wheels touching the outside of the composting drum.

The drum composter may be placed on a frame adapted for its rotation. In the case of the present invention those known solutions may also be used when the drum composter is not positioned on a frame, instead it is placed on the ground on rollers and these enable the composting drum to be rotated. In this case care must be taken so that the semipermeable membrane located on the surface of the composting drum does not get damaged by the rollers or by stones or branches on the ground.

The drum composter according to the present invention may contain one or more composting drums according to the present invention.

### Example 1

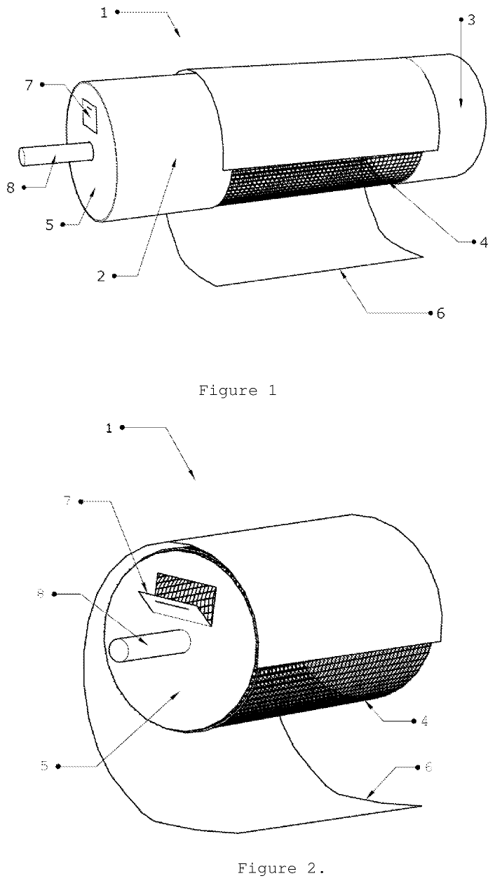

A composting drum 1 according to a preferred embodiment of the present invention is shown in FIG. 1, which contains a drum 2 consisting of a shell 3 and two drum bases 5 (only the one drum base is shown in the figure). In the middle region the shell 3 has mesh-formed perforations 4 and these perforations 4 are partially covered by a semipermeable membrane 6. According to the figure the semipermeable membrane 6 is in the state when it is just being removed from or replaced onto the drum 2. The one drum base 5 contains an opening 7. Furthermore, the composting drum 1 has a shaft 8 for rotating it.

### Example 2

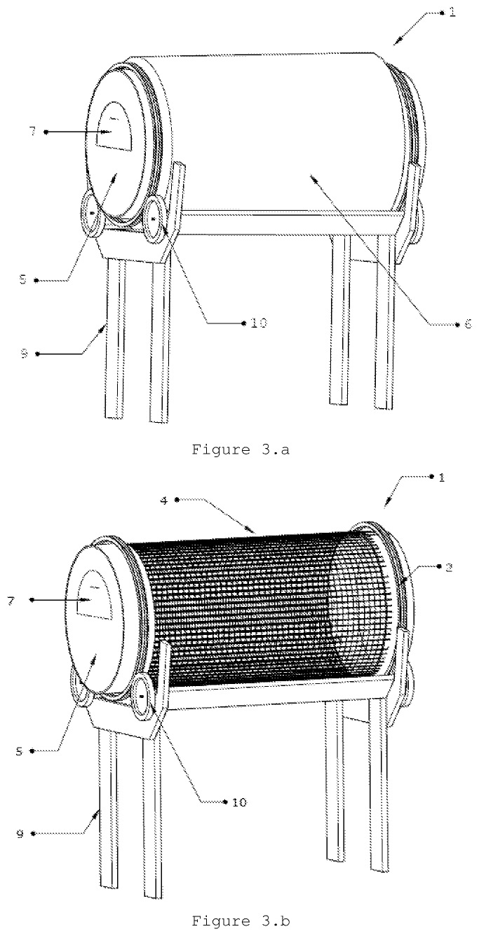

A composting drum 1 according to another preferred embodiment of the present invention is shown in FIG. 2, where the perforations 4 extend over the entire surface of the shell 3 (not numbered in the figure, as it is not separately visible), as a consequence of this the semipermeable membrane 6 completely covers the surface of the drum 2. The composting drum 1 may be rotated around the shaft 8. In this figure also the semipermeable membrane 6 is in the state when it is just being removed from or replaced onto the drum 2. The opening 7 on the drum base 5 may be seen in open state in the figure.

### Example 3

FIGS. 3.a and 3.b show a drum composter according to a preferred embodiment of the present invention where the composting drum 1 is positioned on a frame 9. The shell 3 (not numbered in the figure, as it is not separately visible) of the drum 2 has mesh-formed perforations 4. The one drum base 5 contains an opening 7.

In the state according to FIG. 3.a the semipermeable membrane 6 completely covers the perforations 4 (this is why the perforations cannot be seen in the figure, not numbered). In the state according to FIG. 3.a the composting process progresses in such a way that the composting drum 1 has to be occasionally rotated using the external wheels 10. Due to the use of the external wheels 10 there is no need for a shaft in the interior of the composting drum 1.

In FIG. 3.b the semipermeable membrane 6 has been removed from the composting drum 1. In this way, with the drum composter in this state, the finished (mature) compost (not depicted) is able to leave the composting drum 1 over the course of a number of rotations.

The drum composter according to the present invention operates in such a way that the biodegradable waste to be composted is added into the composting drum 1 through the opening 7 also serving for the insertion of the biodegradable waste to be composted. If the semipermeable membrane 6 is not secured onto the shell 3 of the composting drum 1, then it is secured onto it. Following this the composting process starts and the composting drum 1 is rotated at appropriate intervals. The required frequency of rotations depends on numerous environmental factors known of to a person skilled in the art. Nevertheless, it is preferable if the composting drum 1 is rotated several complete rotations at least every one or two days.

When after a few weeks or months have passed and the composting process has partially or completely finished, the semipermeable membrane 6 is removed from the composting drum 1. Following this, by rotating the composting drum 1 a number of times, the compost particles forming the finished (mature) compost may freely leave through the perforations 4 formed in the perforated composting drum 1. After the finished (mature) compost has been partially or completely emptied out, the composting drum 1 may be cleaned or the composting may be continued with the remaining material in the composting drum 1 or new biodegradable waste may be added into the composting drum 1. Following this the semipermeable membrane 6 must be secured to the surface of the shell 3 of the composting drum 1 containing the perforations 4 in such a way that the semipermeable membrane covers the perforations 4. Following this the next composting cycle may be started in accordance with the above.

It is obvious for a person skilled in the art that the composting drum according to the present invention may be used for smaller, household drum composters, or even for larger, industrial-scale drum composters as well. The reason for this is that in the case of use in any sized composter and in the case of the composting of any amount of biodegradable waste of any composition the technical measures disclosed above may be implemented and its technical advantage disclosed above can be clearly seen. The composting drum according to the present invention may be used easily with the known drum composters, because their known auxiliary devices, such as mixers, further aerators, material transport devices, filling, emptying and cleaning devices used in composting drums may all be directly used in the case of the composting drum according to the present invention, or after optimisation demanding only routine activities. Also, the composting drums of the presently known perforated drum composters may be easily transformed into a composting drum according to the present invention with the appropriate use of the semipermeable membrane detailed above.

The present invention also relates to a drum composter, the essence of which is that it contains the composting drum 1 according to the present invention. Otherwise, the drum composter according to the present invention is built of elements known of well by a person skilled in the art. The drum composter according to the invention may be easily used on its own as a product, and does not require specialist knowledge or the use of other accessories. Therefore, the drum composter according to the invention offers a simple and efficient composting opportunity primarily for household users.

Furthermore, the present invention also relates to the use of the semipermeable membrane 6 disclosed in detail above. As the idea behind the invention is essentially the use of the semipermeable membrane 6 with drum composters known of in themselves. With the use of the semipermeable membrane 6 the efficiency of the known drum composters containing a perforated drum can be significantly increased. The feature of the semipermeable membrane 6 permitting gases and water vapour to pass through it but not liquids and solid material is what ensures the appropriate material flow between the interior of the composting drum 1 and the environment, thereby making other, possibly complex and costly measures unnecessary. The simple use of the semipermeable membrane 6 (essentially attaching it to the composting drum 1, and removing it from there at certain intervals) makes it possible for household users to use the solution according to the present invention in a simple way.

The present invention also relates to a composting method, during which essentially a drum composter containing the composting drum 1 according to the present invention is used to compost biodegradable waste. This is a simple yet effective composting method that may also be implemented by household users without specialist knowledge.

1. Composting drum (1) used with drum composters, a shell (3) of which composting drum (1) has perforations (4), the composting drum (1) has an opening (7) suitable for inserting material to be composted, characterised by that the shell (3) of the composting drum (1) is provided with perforations (4) suitable for the removal of the compost particles and the perforated shell (3) of the composting drum (1) is covered in a removable way with a semipermeable membrane (6) at least over the part with perforations (4).

2. Composting drum (1) according to claim 1, characterised by that the semipermeable membrane (6) is secured with a hook-and-loop fastener.

3. Composting drum (1) according to claim 1, characterised by that the shell (3) of the composting drum (1) is cylindrical.

4. Composting drum (1) according to claim 1, characterised by that the holes (4a) forming the perforations (4) are positioned distributed approximately evenly over the entire surface of the shell (3).

5. Composting drum (1) according to claim 1, characterised by that the average diameter of the holes (4a) forming the perforations (4) is in the range of 10 to 20 mm.

6. Composting drum (1) according to claim 1, characterised by that the semipermeable membrane (6) contains a protective layer and a functional layer.

7. Composting drum (1) according to claim 1, characterised by that the average pore size of the semipermeable membrane (6) is a maximum of 0.5 micrometres, preferably a maximum of 0.3 micrometres.

8. Drum composter, characterised by that it has a composting drum (1) according to claim 1.

9. A method for using a semipermeable membrane (6) for composting performed with drum composters, where the drum composter has a composting drum (1) according to claim 1.

10. Method for composting biodegradable waste, which method contains the following steps:
a) inserting material to be composted into a drum composter that has a composting drum (1) according to claim 1;
b) rotating the drum composter at given intervals or continuously for as much time so that the composting process is at least partially completed;
c) removing the semipermeable membrane (6) from the perforated shell (3) of the composting drum (1);
d) rotating the drum composter in the interest of at least a part of the finished (mature) compost leaving through the perforations (4) of the composting drum (1).
